(19) United States
(12) Patent Application Publication
(10) Pub. No.: US 2002/0147753 A1
(43) Pub. Date: Oct. 10, 2002

(54) Methods and systems for raising a numerical value to a fractional power

(75) Inventors: Raghunath Rao, Austin, TX (US); Girish Subramaniam, Austin, TX (US)

Correspondence Address: James J. Murphy, Esq., WINSTEAD SECHREST & MINICK, 5400 Renaissance Tower, 1201 Elm, Dallas, TX, 75270, US

(73) Assignee: Cirrus Logic, Inc.

(21) Appl. No.: 09/773,058

(22) Filed: Jan. 30, 2001

(51) Int. Cl. G06F 7/38

(52) U.S. Cl. 708/606

(57) ABSTRACT

A method of calculating x^{M/N}, x having a range and M and N integers. The range of x is partitioned into a selected number of intervals and a determination is made as to the interval into which x falls. x is normalized with a normalization factor calculated for the interval into which x falls to obtain a normalized value x′ within a normalized range. A value of x′^{M/N} is calculated over the normalized range and a value for x^{M/N} is calculated by multiplying the calculated value of x′^{M/N} by a renormalization factor calculated for the interval in which x falls.

### FIELD OF THE INVENTION

The present invention relates in general to digital signal processing and in particular to circuits, systems, and methods for raising a numerical value to a fractional power.

### DESCRIPTION OF THE RELATED ART

In a number of digital signal processing applications it is necessary to raise a given numerical value to a fractional power. For example, digital audio is commonly compressed using non-linear quantization techniques. In one such technique, time domain samples of an analog audio stream are transformed into the frequency domain. The resulting frequency domain samples are then raised to the ¾^{th} power and then linearly quantized. By raising samples to the ¾^{th} power, the dynamic range of the bitstream is compressed such that the steps in the linear quantization operation roughly equalize the relative noise imparted over the different amplitude samples.

Current techniques for raising a numerical value to a fractional power are difficult to perform, especially in fixed point machines. Consequently, given their importance in digital signal processing applications, new methods and systems are required for raising a numerical value to a fractional power.

### SUMMARY OF THE INVENTION

A method of calculating x^{M/N}, x having a range, and m and n are integers. The range of x is partitioned into a selected number of intervals and a determination is made as to the interval into which x falls. X is normalized with a normalization factor calculated for the interval into which x falls to obtain a normalized value x′ within a normalized range. A value of x′^{M/N} is calculated over the normalized range, a value for x^{M/N} is calculated by multiplying x′^{(M/N)} by the renormalization factor calculated for the interval in which x falls.

The inventive concepts allow for the precise performance of the operation of raising a numerical value to a fractional power. These concepts are particularly useful in digital signal processing applications operating on binary data, although not necessarily limited thereto. Moreover, implementation of the inventive principles does not require an inordinate amount of look-up table memory or the execution of a burdensome number of additional instructions.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a diagram of a multichannel audio decoder embodying the principles of the present invention;

FIG. 1B is a diagram showing the decoder of FIG. 1 in an exemplary system context;

FIG. 1C is a diagram showing the partitioning of the decoder into a processor block and an input/output (I/O) block;

FIG. 2 is a diagram of the processor block of FIG. 1C;

FIG. 3 is a diagram of the primary functional subblocks of the I/O block of FIG. 1C;

FIG. 4 is a diagram of the interprocessor communications (IPC) registers as shown in FIG. 3; and

FIG. 5 is a flow chart illustrating a preferred method of raising a numerical value to a functional power in accordance with the inventive principles.

### DESCRIPTION OF THE PREFERRED EMBODIMENTS

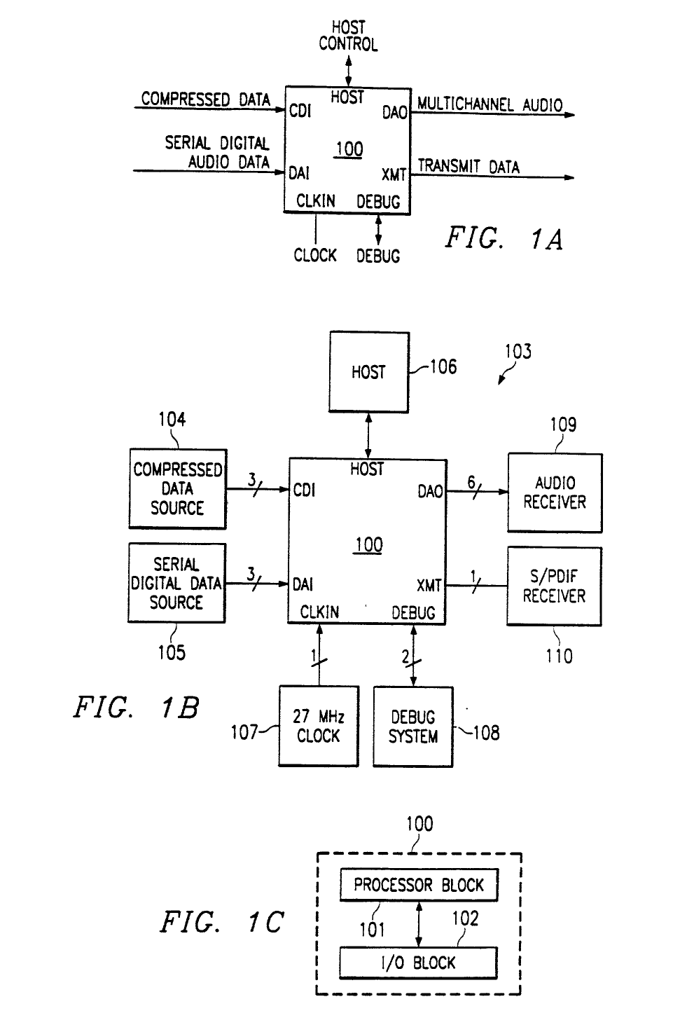

The principles of the present invention and their advantages are best understood by referring to the illustrated embodiment depicted in FIGS. 1-5 of the drawings, in which like numbers designate like parts.

FIG. 1A is a general overview of an audio information decoder 100 embodying the principles of the present invention. Decoder 100 is operable to receive data in any one of a number of formats, including compressed data conforming to the AC-3 digital audio compression standard, (as defined by the United States Advanced Television System Committee) through a compressed data input port CDI. An independent digital audio data (DAI) port provides for the input of PCM, S/PDIF, or non-compressed digital audio data.

A digital audio output (DAO) port provides for the output of multiple-channel decompressed digital audio data. Independently, decoder 100 can transmit data in the S/PDIF (Sony-Phillips Digital Interface) format through transmit port XMT.

Decoder 100 operates under the control of a host microprocessor through a host port HOST and supports debugging by an external debugging system through the debug port DEBUG. The CLK port supports the input of a master clock for generation of the timing signals within decoder 100.

While decoder 100 can be used to decompress other types of compressed digital data, it is particularly advantageous to use decoder 100 for decompression of AC-3 Bitstreams. Therefore, for understanding the utility and advantages of decoder 100, consider the case of when the compressed data received at the compressed data input (CDI) port has been compressed in accordance with the AC-3 standard.

Generally, AC-3 data is compressed using an algorithm which achieves high coding gain (i.e., the ratio of the input bit rate to the output bit rate) by coarsely quantizing a frequency domain representation of the audio signal. To do so, an input sequence of audio PCM time samples is transformed to the frequency domain as a sequence of blocks of frequency coefficients. Generally, these overlapping blocks, each composed of 512 time samples, are multiplied by a time window and transformed into the frequency domain. Because the blocks of time samples overlap, each PCM input sample is represented by two sequential blocks factor transformated into the frequency domain. The frequency domain representation may then be decimated by a factor of two such that each block contains 256 frequency coefficients, with each frequency coefficient represented in binary exponential notation as an exponent and a mantissa.

Next, the exponents are encoded into coarse representation of the signal spectrum (spectral envelope), which is in turn used in a bit allocation routine that determines the number of bits required to encoding each mantissa. The spectral envelope and the coarsely quantized mantissas for six audio blocks (1536 audio samples) are formatted into an AC-3 frame. An AC bit stream is a sequence of the AC-3 frames.

In addition to the transformed data, the AC-3 bit stream also includes additional information. For instance, each frame may include a frame header which indicates the bit rate, sample rate, number of encoded samples, and similar information necessary to subsequently synchronize and decode the AC-3 bit stream. Error detection codes may also inserted such that the device such as decoder 100 can verify that each received frame of AC-3 data does not contain any errors. A number of additional operations may be performed on the bit stream before transmission to the decoder. For a more complete definition of AC-3 compression, reference is now made to the digital audio compression standard (AC-3) available from the Advanced Televisions Systems Committee, incorporated herein by reference.

In order to decompress under the AC-3 standard, decoder 100 essentially must perform the inverse of the above described process. Among other things, decoder 100 synchronizes to the received AC-3 bit stream, checks for errors and deformats the received AC-3 data audio. In particular, decoder 100 decodes spectral envelope and the quantitized mantissas. A bit allocation routine is used to unpack and de-quantitize the mantissas. The spectral envelope is encoded to produce the exponents, then, a reverse transformation is performed to transform the exponents and mantissas to decoded PCM samples in the time domain. Subsequently, post processing of the PCM audio can be performed using various algorithms including digital tone control. The final PCM is converted to an analog signal via a DAC and then processed by a typical analog signal chain to speakers.

FIG. 1B shows decoder 100 embodied in a representative system 103. Decoder 100 as shown includes three compressed data input (CDI) pins for receiving compressed data from a compressed audio data source 104 and an additional three digital audio input (DAI) pins for receiving serial digital audio data from a digital audio source 105. Examples of compressed serial digital audio source 105, and in particular of AC-3 compressed digital sources, are digital video discs and laser disc players.

Host port (HOST) allows coupling to a host processor 106, which is generally a microcontroller or microprocessor that maintains control over the audio system 103. For instance, in one embodiment, host processor 106 is the microprocessor in a personal computer (PC) and System 103 is a PC-based sound system. In another embodiment, host processor 106 is a microcontroller in an audio receiver or controller unit and system 103 is a non-PC-based entertainment system such as conventional home entertainment systems produced by Sony, Pioneer, and others. A master clock, shown here, is generated externally by clock source 107. The debug port (DEBUG) consists of two lines for connection with an external debugger, which is typically a PC-based device.

Decoder 100 has six output lines for outputting multi-channel audio digital data (DAO) to digital audio receiver 109 in any one of a number of formats including 3-lines out, 2/2/2, 4/2/0, 4/0/2 and 6/0/0. A transmit port (XMT) allows for the transmission of S/PDIF data to an S/PDIF receiver 110. These outputs may be coupled, for example, to digital to analog converters or codecs for transmission to analog receiver circuitry.

FIG. 1C is a high level functional block diagram of a multichannel audio decoder 100 embodying the principles of the present invention. Decoder 100 is divided into two major sections, a Processor Block 101 and the I/O Block 102. Processor Block 106 includes two digital signal processor (DSP) cores, DSP memory, and system reset control. I/O Block 102 includes interprocessor communication registers, peripheral I/O units with their necessary support logic, and interrupt controls. Blocks 101 and 102 communicate via interconnection with the I/O buses of the respective DSP cores. For instance, I/O Block 102 can generate interrupt requests and flag information for communication with Processor Block 101. All peripheral control and status registers are mapped to the DSP I/O buses for configuration by the DSPs.

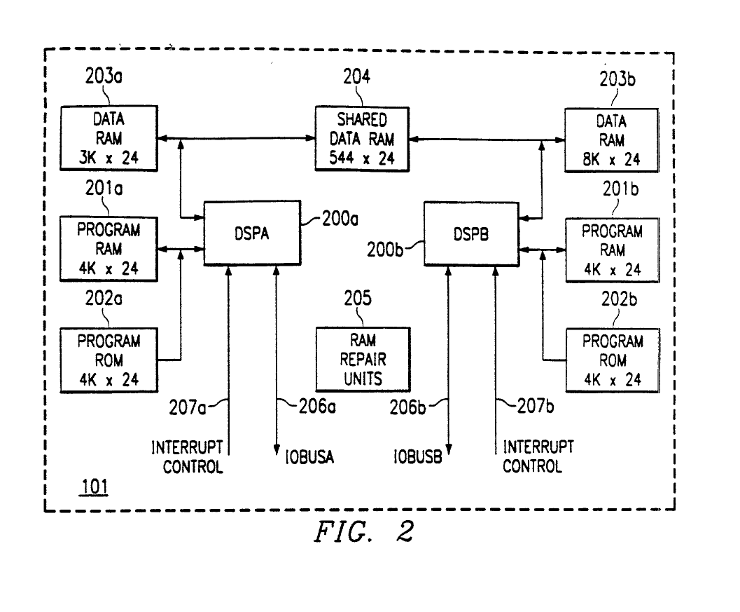

FIG. 2 is a detailed functional block diagram of processor block 101. Processor block 101 includes two DSP cores 200a and 200b, labeled DSPA and DSPB respectively. Cores 200a and 200b operate in conjunction with respective dedicated program RAM 201a and 201b, program ROM 202a and 202b, and data RAM 203a and 203b. Shared data RAM 204, which the DSPs 200a and 200b can both access, provides for the exchange of data, such as PCM data and processing coefficients, between processors 200a and 200b. Processor block 101 also contains a RAM repair unit 205 that can repair a predetermined number of RAM locations within the on-chip RAM arrays to increase die yield.

DSP cores 200a and 200b respectively communicate with the peripherals through I/O Block 102 via their respective I/O buses 206a, 206b. The peripherals send interrupt and flag information back to the processor block via interrupt interfaces 207a, 207b.

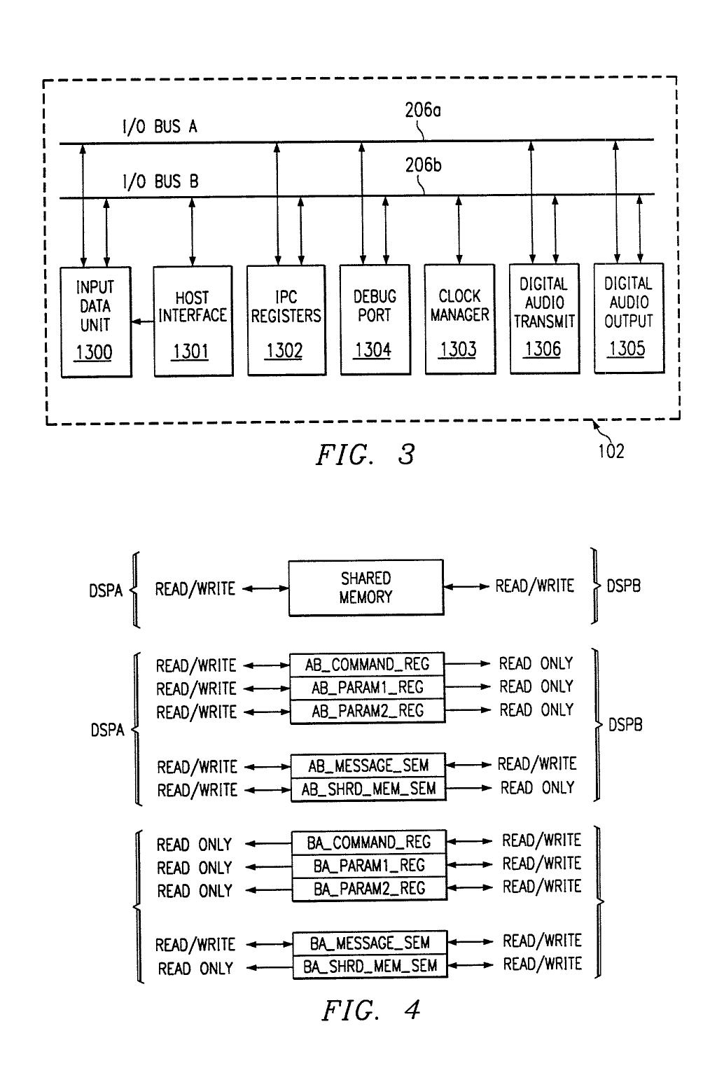

FIG. 3 is a detailed functional block diagram of I/O block 102. Generally, I/O block 102 contains peripherals for data input, data output, communications, and control. Input Data Unit 1300 accepts either compressed analog data or digital audio in any one of several input formats (from either the CDI or DAI ports). Serial/parallel host interface 1301 allows an external controller to communicate with decoder 100 through the HOST port. Data received at the host interface port 1301 can also be routed to input data unit 1300.

IPC (Inter-processor Communication) registers 1302 support a control-messaging protocol for communication between processing cores 200 over a relatively low-bandwidth communication channel. High-bandwidth data can be passed between cores 200 via shared memory 204 in processor block 101.

Clock manager 1303 is a programmable PLL/clock synthesizer that generates common audio clock rates from any selected one of a number of common input clock rates through the CLKIN port. Clock manager 1303 includes an STC counter which generates time information used by processor block 101 for managing playback and synchronization tasks. Clock manager 1303 also includes a programmable timer to generate periodic interrupts to processor block 101.

Debug circuitry 1304 is provided to assist in applications development and system debug using an external DEBUGGER and the DEBUG port, as well as providing a mechanism to monitor system functions during device operation.

A Digital Audio Output port 1305 provides multichannel digital audio output in selected standard digital audio formats. A Digital Audio Transmitter 1306 provides digital audio output in formats compatible with S/PDIF or AES/EBU.

In general, I/O registers are visible on both I/O buses, allowing access by either DSPA (200a)or DSPB (200b). Any read or write conflicts are resolved by treating DSPB as the master and ignoring DSPA.

The principles of the present invention further allow for methods of controlling the tone levels of decompressed audio data, as well as for methods and software for operating decoder 100. These principles will be discussed in further detail below. Initially, a brief discussion of the theory of operation of decoder 100 will be undertaken.

In a dual-processor environment like decoder 100, it is important to partition the software application optimally between the two processors 200a, 200b to maximize processor usage and minimize inter-processor communication. For this, the dependencies and scheduling of the tasks of each processor must be analyzed. The algorithm must be partitioned such that one processor does not unduly wait for the other and later be forced to catch up with pending tasks. For example, in most audio decompression tasks including Dolby AC-3®, the algorithm being executed consists of 2 major stages: 1) parsing the input bitstream with specified/computed bit allocation and generating frequency-domain transform coefficients for each channel; and 2) performing the inverse transform to generate time-domain PCM samples for each channel. Based on this and the hardware resources available in each processor, and accounting for other housekeeping tasks the algorithm can be suitably partitioned.

Usually, the software application will explicitly specify the desired output precision, dynamic range and distortion requirements. Apart from the intrinsic limitation of the compression algorithm itself, in an audio decompression task the inverse transform (reconstruction filter bank) is the stage which determines the precision of the output. Due to the finite-length of the registers in the DSP, each stage of processing (multiply+accumulate) will introduce noise due to elimination of the lesser significant bits. Adding features such as rounding and wider intermediate storage registers can alleviate the situation.

For example, Dolby AC-3® requires 20-bit resolution PCM output which corresponds to 120 dB of dynamic range. The decoder uses a 24-bit DSP which incorporates rounding, saturation and 48-bit accumulators in order to achieve the desired 20-bit precision. In addition, analog performance should at least preserve 95 dB S/N and have a frequency response of +/−0.5 dB from 3 Hz to 20 kHz.

Based on application and design requirements, a complex real-time system, such as audio decoder 100, is usually partitioned into hardware, firmware and software. The hardware functionality described above is implemented such that it can be programmed by software to implement different applications. The firmware is the fixed portion of software portion including the boot loader, other fixed function code and ROM tables. Since such a system can be programmed, it is advantageously flexible and has less hardware risk due to simpler hardware demands.

There are several benefits to the dual core (DSP) approach according to the principles of the present invention. DSP cores 200A and 200B can work in parallel, executing different portions of an algorithm and increasing the available processing bandwidth by almost 100%. Efficiency improvement depends on the application itself. The important thing in the software management is correct scheduling, so that the DSP engines 200A and 200B are not waiting for each other. The best utilization of all system resources can be achieved if the application is of such a nature that can be distributed to execute in parallel on two engines. Fortunately, most of the audio compression algorithms fall into this category, since they involve a transform coding followed by fairly complex bit allocation routine at the encoder. On the decoder side the inverse is done. Firstly, the bit allocation is recovered and the inverse transform is performed. This naturally leads into a very nice split of the decompression algorithm. The first DSP core (DSPA) works on parsing the input bitstream, recovering all data fields, computing bit allocation and passing the frequency domain transform coefficients to the second DSP (DSPB), which completes the task by performing the inverse transform (IFFT or IDCT depending on the algorithm). While the second DSP is finishing the transform for a channel n, the first DSP is working on the channel n+1, making the processing parallel and pipelined. The tasks are overlapping in time and as long as tasks are of similar complexity, there will be no waiting on either DSP side. Once the transform for each channel is completed, DSPB can postprocess this PCM data according to the desired algorithm, which could include digital tone control.

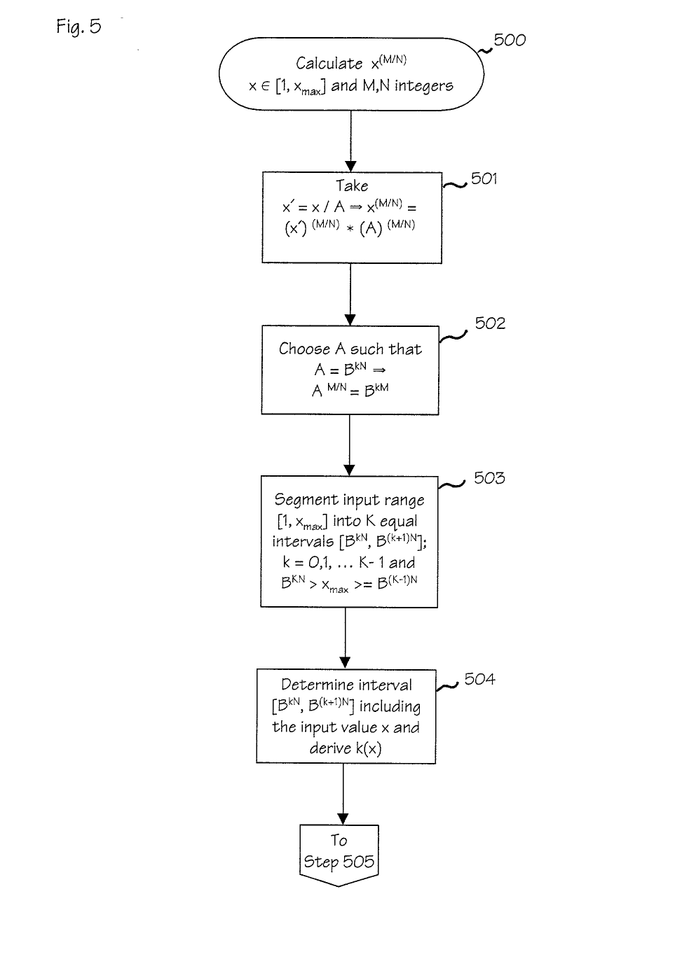

Decoder 100, as discussed above, includes shared memory of 544 words as well as communication “mailbox” (IPC block 1302) consisting of 10 I/O registers (5 for each direction of communication). FIG. 4 is a diagram representing the shared memory space and IPC registers (1302).

One set of communication registers looks like this:

| | |
|---|---|
| (a) | AB_command_register (DSPA write/read, DSPB read |
| | only) |
| (b) | AB_parameter1_register (DSPA write/read, DSPB |
| | read only) |
| (c) | AB_parameter2_register (DSPA write/read, DSPB |
| | read only) |
| (d) | AB_message_semaphores (DSPA write/read, DSPB |
| | write/read as well) |
| (e) | AB_shared_memory_semaphores (DSPA write/read, |

DSP B read only) where AB denotes the registers for communication from DSPA to DSPB. Similarly, the BA set of registers are used in the same manner, with simply DSPB being primarily the controlling processor.

Shared memory 204 is used as a high throughput channel, while communication registers serve as low bandwidth channel, as well as semaphore variables for protecting the shared resources.

Both DSPA and DSPA 200a, 200b can write to or read from shared memory 204. However, software management provides that the two DSPs never write to or read from shared memory in the same clock cycle. It is possible, however, that one DSP writes and the other reads from shared memory at the same time, given a two-phase clock in the DSP core. This way several virtual channels of communications could be created through shared memory. For example, one virtual channel is transfer of frequency domain coefficients of AC-3 stream and another virtual channel is transfer of PCM data independently of AC-3. While DSPA is putting the PCM data into shared memory, DSPB might be reading the AC-3 data at the same time. In this case both virtual channels have their own semaphore variables which reside in the AB_shared_memory_semaphores registers and also different physical portions of shared memory are dedicated to the two data channels. AB_command_register is connected to the interrupt logic so that any write access to that register by DSPA results in an interrupt being generated on the DSP B, if enabled. In general, I/O registers are designed to be written by one DSP and read by another. The only exception is AB_message_sempahore register which can be written by both DSPs. Full symmetry in communication is provided even though for most applications the data flow is from DSPA to DSP B. However, messages usually flow in either direction, another set of 5 registers are provided as shown in FIG. 4 with BA prefix, for communication from DSPB to DSPA.

The AB_message_sempahore register is very important since it synchronizes the message communication. For example, if DSPA wants to send the message to DSPB, first it must check that the mailbox is empty, meaning that the previous message was taken, by reading a bit from this register which controls the access to the mailbox. If the bit is cleared, DSPA can proceed with writing the message and setting this bit to 1, indicating a new state, transmit mailbox full. DSPB may either poll this bit or receive an interrupt (if enabled on the DSPB side), to find out that new message has arrived. Once it processes the new message, it clears the flag in the register, indicating to DSPA that its transmit mailbox has been emptied. If DSPA had another message to send before the mailbox was cleared it would have put in the transmit queue, whose depth depends on how much message traffic exists in the system. During this time DSPA would be reading the mailbox full flag. After DSPB has cleared the flag (set it to zero), DSPA can proceed with the next message, and after putting the message in the mailbox it will set the flag to I. Obviously, in this case both DSPs have to have both write and read access to the same physical register. However, they will never write at the same time, since DSPA is reading flag until it is zero and setting it to 1, while DSPB is reading the flag (if in polling mode) until it is 1 and writing a zero into it. These two processes a staggered in time through software discipline and management.

When it comes to shared memory a similar concept is adopted. Here the AB_shared_memory semaphore register is used. Once DSPA computes the transform coefficients but before it puts them into shared memory, it must check that the previous set of coefficients, for the previous channel has been taken by the DSPB. While DSPA is polling the semaphore bit which is in AB_shared_memory_semaphore register it may receive a message from DSPB, via interrupt, that the coefficients are taken. In this case DSPA resets the semaphore bit in the register in its interrupt handler. This way DSPA has an exclusive write access to the AB_shared_memory semaphore register, while DSPB can only read from it. In case of AC-3, DSPB is polling for the availability of data in shared memory in its main loop, because the dynamics of the decode process is data driven. In other words there is no need to interrupt DSPB with the message that the data is ready, since at that point DSPB may not be able to take it anyway, since it is busy finishing the previous channel. Once DSPB is ready to take the next channel it will ask for it. Basically, data cannot be pushed to DSPB, it must be pulled from the shared memory by DSPB.

The exclusive write access to the AB_shared_memory_semaphore register by DSPA is all that more important if there is another virtual channel (PCM data) implemented. In this case, DSPA might be putting the PCM data into shared memory while DSPB is taking AC-3 data from it. So, if DSPB was to set the flag to zero, for the AC-3 channel, and DSPA was to set PCM flag to 1 there would be an access collision and system failure will result. For this reason, DSPB is simply sending message that it took the data from shared memory and DSPA is setting shared memory flags to zero in its interrupt handler. This way full synchronization is achieved and no access violations performed.

For a complete description of exemplary decoder 100 and its advantages, reference is now made to coassigned U.S. Pat. No. 6,081,783 entitled “DIGITAL AUDIO DECODING CIRCUITRY, METHODS AND SYSTEMS”.

As discussed briefly above, it is common in audio compression schemes to raise the numerical value of the audio samples, and in particular those which have been transformed into the frequency domain, to a fractional power during encoding to compress the dynamic range of the signal. The step size in the subsequent linear quantization therefore imparts a relatively equal amount of noise over the input sample amplitude range. Exemplary audio formats where this technique is employed include MPEG-1 and MPEG-2 Layer III (MP3) and MPEG Advanced Audio enCoding (AAC), although the processing to obtain the frequency domain samples differ substantially.

The operation of raising the numerical number of a sample is difficult to implement on a DSP, and in particular those based on a fixed point architecture. This is particularly true when trying to maintain precision while at the same time minimizing MIPS and memory usage. For example, lookup tables could be used, however given the large number of possible input values encountered in applications such as MP3 and AAC these tables would become prohibitively large. This is especially true for the encoding process since the number of possible input values is as large as the numeric precision allowed by the processor. Moreover, a series expansion, such as a Taylor series, could be performed; however, in this case, precision is sacrificed in order to keep the number of expansion terms reasonable and cover the large range of the input. In particular, for the calculation x^{¾}, which is used in MP3 and AAC encoding, this series expansion precision is insufficient, even when 12 terms are taken, with coefficients less that 10⁻¹⁰ past the third term.

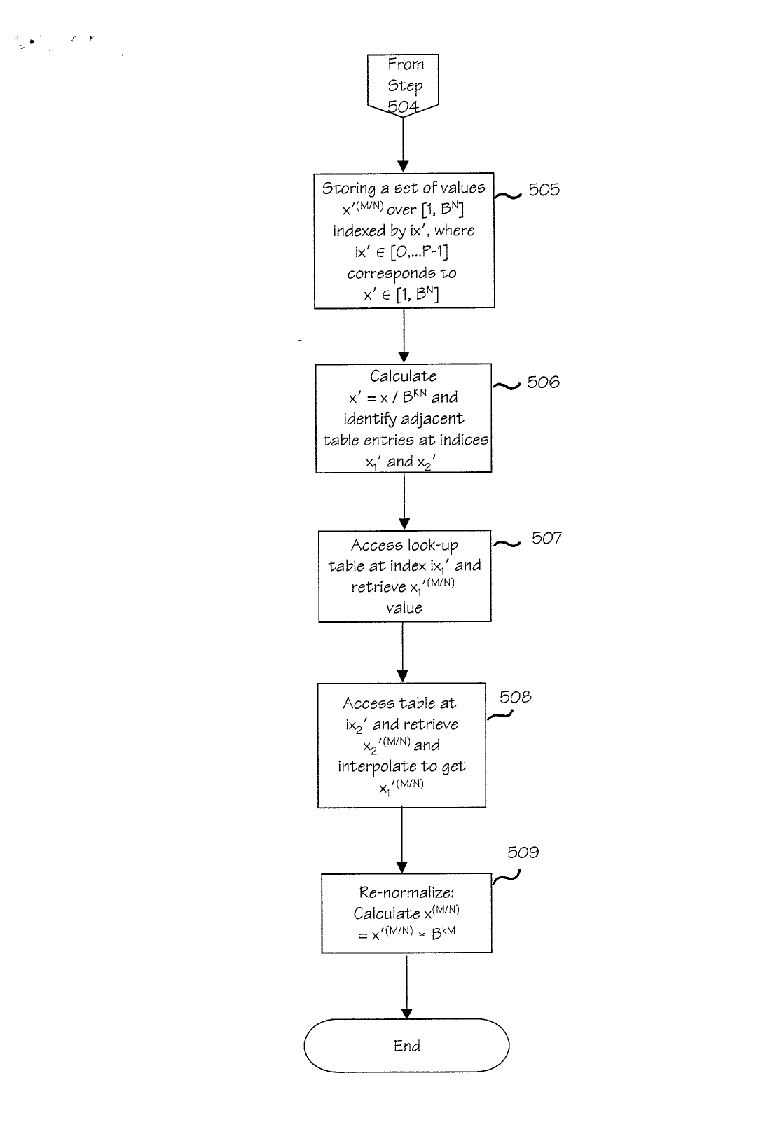

A preferred procedure 500 for raising a numerical input value x to a fractional power M/N is illustrated in the flow chart of FIG. 5. In this example, x will be assumed to take on values in the un-normalized range [1, xₘₐₓ] for M, N integers. Values in the range (0,1) are simply handled by scaling the range up, with 0 being the special trivial case. As discussed further below, this procedure can also be used to take the logarithm of a given input value x. Procedure 500 is particularly useful in DSP applications, such as audio decoder 100, although not necessarily limited thereto.

At Step 501, the input value x is divided by a selected normalization factor A to obtain the normalized value x′ where:

x^{(M/N)}=(x′)^{(M/N)}*(A)^{(M/N)} (1)

Preferably, A is selected (Step 502) such that:

A=B^{kN}→(A)^{(M/N)}=B^{kM} (2)

At Step 503, the un-normalized range [1, xₘₐₓ) of the input value x is partitioned into K number of equal intervals [B^{kN}, B^{(k+1)N}), where B^{KN}>xₘₐₓ>=B^{(K-1)N} and k=0,1 . . . (K-1). By varying the value of B, different performance tradeoffs are implemented. For example, if a small value of B (i.e. a large number of intervals) is chosen, greater precision is achieved in the calculation of k(x) discussed below, although additional complexity is introduced into the procedure of computing the intervals. On the other hand, if a larger value is chosen for B, the calculation of the intervals is less complex, but done at the expense of accuracy in calculating k(x).

Consequently, each equal interval [B^{kN}, B^{(k+1)N}) is mapped by the normalization factor B^{kN} into the normalized range [1, x′ₘₐₓ), where x′ₘₐₓ=B^{N} since:

x′=x/B^{kN} (3)

At Step 504, the value of k(x) is determined. This could be done by calculating k(x)=floor[1/N*log_{B}(x)+1]. This is an operation intensive calculation to perform, especially for fixed point processors. However, in accordance with the inventive concepts, k(x) is preferably determined using a much more straight forward operation. Specifically, at Step 504 comparisons are made to determine in which of the intervals [B^{kN}, B^{(k+1)N}) the input value x falls, from which k(x) is derived. It should be noted that this procedure is applicable to instances where x is less than 1, although the value of k must now be negative.

Values for (x′)^{(M/N)}, over the normalized range [1, B^{N}] have been calculated and stored in a look-up table of P entries, these entries indexed by mapping the value of x′ to an appropriate index (Step 505) The number of values stored will depend not only on B^{N}, but also the resolution (steps) in the values of (x′)^{(M/N)} stored. As discussed further below, additional precision can be achieved using linear interpolation or the like upon retrieval of pairs of these stored values.

The normalized value x′ is then calculated at Step 506. This is used to index the look up table using index values iX₁′ and ix₂′ calculated as follows:

z′=(x′−1)*(P−1)/(B^{N}−1); (4)

ix₁′=floor(z′); and (5)

ix₂′=ix₁′+1. (6)

The corresponding stored value of (x₁′)^{(M/N)} over the normalized range [1, B^{N}] is retrieved using the index ix₁′ at Step 507, along with the value (x₂′)^{(M/N)} at index ix₂′. Depending on the resolution of the values in the look-up table, linear interpolation can be performed to increase the precision. Since, x′₁<x′<x′₂ and the values for (x′₁)^{(M/N)} and (x′₂)^{(M/N)} have been retrieved from the look-up table, then at Step 508 a linear interpolation is performed:

(x′)^{(M/N)}=α(x′₁)^{(M/N)}+(1−α)(x′₂)^{(M/N)}, where: (7)

α=1−(z′−ix′₁). (8)

A series expansion can also be implemented instead of the look-up table retrievals and linear interpolation over the limited normalized range, with good performance.

To obtain the final value of x^{(M/N)}, renormalization is performed at Step 509 by multiplying the final result (interpolated, expanded or directly taken from the lookup table) by the renormalization factor B^{kM}:

x^{(M/N)}=(x′)^{(M/N)}*A^{(M/N)}=(x′)^{(M/N)}*B^{kM} (9)

Renormalization is a straightforward calculation since B^{kM} is easily computable and B, k and M are known. Typically, B^{kM} is retrieved by looking up a prestored value.

In instances where M>N, greater accuracy can be achieved by splitting x^{(M/N)} into x^{M}^{₁}*x^{(M}^{₂}^{/N)}, where M=M₁*N+M₂ and M₂<N, calculating x^{(M}^{₂}^{/N)} using one of the procedures described above, and then multiplying the result by x^{M}^{₁}. The procedure described above can also be used to calculate the logarithm, to a given base, for a given input value x. In this case, x is normalized such that the normalized value x′ falls with in a selected range. The logarithm of x′ is then calculated over that range, using either the look-up table, look-up table with interpolation or series expansion approach. Finally the calculated value is added to the interval times log B to obtain the actual value of log x.

The concepts generally described above have distinct advantages when operating on binary data. In particular, with appropriate parameter selection, the process of raising a number to a fractional power can be reduced to a series of fundamental operations, such as left and right shifts and a table look-up operation. Consider the following example.

Assume that the quantity being evaluated is x^{¾}(i.e. M=3, N=4) and that the B=2, since the data is binary. Also assume that the operations are taking place in a 24-bit processing architecture using 5 bits for fractional representation such that Xₘₐₓ=(2²³−1)/2⁵ The values of x, x′, A and k for this set of conditions are tabulated in Table 1:

TABLE 1

| x | x′ = x/A | A = 2^{4k} | k | Shift 1 | Shift 2 |
|---|---|---|---|---|---|
| [1/16 . . . 31/32) | [1 . . . 16) | 1/16 | −1 | L-18 | R-15 |
| [1, 1 1/32, | [1 . . . 16) | 1 | 0 | L-14 | R-12 |
| 1 2/32 . . . 15 | | | | | |
| 31/32] | | | | | |
| 16, 16 | [1 . . . 16) | 16 | 1 | L-10 | R-9 |
| 1/32 . . . 255 | | | | | |
| 31/32] | | | | | |
| [256 . . . 2¹²- | [1 . . . 16) | 256 | 2 | L-6 | R-2 |
| 1/32] | | | | | |
| [2¹² . . . 2¹⁶- | [1 . . . 16) | 2¹² | 3 | L-2 | R-3 |
| 1/32] | | | | | |
| [2¹⁶ . . . 2²⁰- | [1 . . . 16) | 2¹⁶ | 4 | R-2 | 0 |
| 1/32] | | | | | |

Note that 0 is a trivial special case and 1/32 is also treated specially by forcing its ¾ power to be zero. All other fixed point cases of interest are covered above.

In this example, the values of x are normalized to values x′ within the range [1, . . . , 16]. The range [1, 16] is partitioned into a 241 entry table, with indices in the range 0 to 240 storing values of (x′)^{¾} in steps of 1/16 from 1^{¾} to (16)^{¾} (This resolution was arbitrarily chosen for this example, and may change between implementations. In general, a P-element table will result in the storage of (x′)^{¾} for R=(B^{N}−1)/(P−1) fractional steps of resolution).

Specifically, these entries are populated with corresponding values of (x′)^{¾} in the range from 1^{¾} to (16)^{¾}. Hence, in this example Entry is populated with the value 1^{¾}, Entry 1 with the value (1 1/16)^{¾}, and so on with Entry 240 (the 241^{st} element) is populated with the value (16)^{¾}. Preferably, the entries are stored in the 5.19 format. (Since the largest value in the table (16)^{¾} simply equals 8, four integer bits are required along with one sign bit and, for 24-bit data, the remaining 19 bits represent the fractional part.)

Continuing with the example, assume that x takes on the value of 17 1/32. In 19.5 binary form (1 sign bit, 18 integer places, 5 fractional places, Base 2), this becomes:

0 00 0000 0000 0001 0001.00001

This value is shifted by the number of places and in the direction specified in the Shift 1 column of Table 1. The number of places in the shift is a function of the number of integer bits required to represent the integer part x. For example, if x is in the range [1,16) then four integer bits are required to represent the integer part and a left shift of 14 places is performed. On the other hand, if x is in the range [16, 256), 8 integer bits are required for the integer and a shift left of 10 places is needed. For the 17 1/32 example, the shift is left by 10 places such that x′ becomes (in 5.19 format):

0 0001.0001 00001 0000 0000 00

This x′ is adjusted by subtracting 1 to get z′ as

0 0000.0001 0000 1000 0000 000

Since ((P−1)/(B^{N}−1))=240/15=16, the binary point is shifted right (value shifted left) by 4=Log₂ 16 places to obtain the index.

The upper 8 bits (not including the sign bit), representing the integer 1 are used to index the (x′)^{¾} look-up table value and the lower 15 bits, representing the fraction 1/32, are used as the interpolation factor α. In this case, the look-up table entry at index 1 is (17/16)^{¾}. The value (18/16)^{¾} from Entry 2 is also taken for interpolation.

One method of interpolation is to apply linear interpolation using entries 1 and 2 and the α taken from the fractional part of 2′, after shifting, using linear interpolation in accordance with Equation (6) above.

Once the interpolated value of (x′)^{¾} is found, x^{¾} is found by multiplying (x′)^{¾} by B^{kM} to renormalize. In this case, since B=2, this is done by simply shifting by the amount Shift 2 in Table 1 to obtain x^{¾} in the 15.9 binary format.

A similar procedure can be used to obtain the inverse x^{4/3}, which becomes useful in decoding the compressed data. Here x^{⅓} is computed using the above method, and the result multiplied by x to obtain x^{¾}.

Although the present invention and its advantages have been described in detail, it should be understood that various changes, substitutions and alterations can be made herein without departing from the spirit and scope of the invention as defined by the appended claims.

What is claimed is:

1. A method of calculating x^{M/N}, wherein x has a value in a range (0, xₘₐₓ] and M and N are integers, comprising the steps of:
partitioning the range (0, xₘₐₓ] into a plurality of K number of intervals [B^{k}, B^{(k+1)N}], where B>1 and k=−1, 0, 1 . . . K;
determining the interval [B^{k}, B^{(k+1)N}] in which x falls and deriving a value of k therefrom;
dividing x by a normalization factor B^{kN} to obtain a normalized value x′;
computing a value of x′^{(M/N)} for the normalized value x′; and
renormalizing by multiplying x′^{(M/N)}, by B^{kM} to obtain x^{M/N}.

2. The method of claim 1 wherein said step of computing comprises the step of retrieving the value of x′^{M/N} from a look-up table indexed by the normalized value x′.

3. The method of claim 1 wherein x^{M/N} is calculated in binary form and B is equal to 2.

4. The method of claim 1 wherein said step of calculating comprises the step of performing a series expansion to calculate the value x′^{(M/N)} for the normalized value x′.

5. The method of claim 2 and further comprising the step of interpolating between the value x′^{(M/N)} retrieved for a first quantized approximation of the normalized value x′ and a second quatized approximation of the value of x′^{(M/N)} retrieved for a second value of x′.

6. The method of claim 1 wherein the method is implemented in a program executed by a digital signal processor.

7. The method of claim 1 wherein said steps are performed using fixed point operations.

8. A method of calculating x^{M/N}, x having a range and M and N are integers, comprising the steps of:
partitioning the range of x into selected number of intervals;
determining the interval into which x falls;
normalizing x with a normalization factor calculated for the interval into which x falls to obtain a normalized value x′ within a normalized range;
determining a value for x′^{(M/N)} from x′ within the normalized range; and
renormalizing by multiplying x′^{(M/N)} by a renormalization factor calculated for the interval in which x falls obtain x^{M/N}.

9. The method of claim 8 wherein said step of determining comprises the substeps of:
storing a plurality of values of x′^{(M/N)} over the normalized range in a table; and
retrieving a value of x′^{(M/N)} from the table for the normalized value x′

10. The method of claim 8 wherein the normalization factor is B^{Kn} where B is the base in which x^{M/N} is calculated and k is an index between 0 and K−1 of the interval into which x falls, the range of x divided into K number of intervals.

11. The method of claim 8 wherein the renormalization factor is B^{kM}.

12. The method of claim 9 and further comprising the step of retrieving a second value x″^{(M/N)} corresponding to a second normalized value x″ and interpolating between the retrieved value of x′^{(M/N)} and the second retrieved value x″^{(M/N)}.

13. The method of claim 12 wherein said step of interpolating comprises the step of linearly interpolating in accordance with the formula:
x′^{(M/N)}=α(x′^{(M/N)})+(1−α)x″^{(M/N)}
where α is an interpolation factor.

14. The method of claim 8 wherein M>N and the method comprises the steps of factoring x^{M}^{₁}*x^{(M}^{₂}^{/N)}, where M=M₁*N+M₂ and M₂<N, and calculating x^{(M}^{₂}^{/N)}.

15. The method of claim 8 wherein said steps of normalizing and renormalizing are implemented in fixed point operations.

16. A method of calculating a value of a function f(x) for a binary input value x within an un-normalized range comprising the steps of:
shifting a received input value x by a selected number of places in a selected direction to normalized the value of x to a normalized value x′ in the normalized range;
calculating a value f(x′) for the function f(x) for data point x′ in the normalized range; and
shifting the calculated value of x′ in a selected direction to obtain the value of f(x) for the input value x.

17. The method of claim 16 wherein f(x)=x^{M/N}, where M and N are integers.

18. The method of claim 17 wherein the normalized range is selected to be [1, B^{N}).

19. The method of claim 16 wherein said step of calculating comprises the substeps:
storing values f(x′) of the function f(x) for a set of normalized values x′ over a selected normalized range in a table; and
indexing the table with part of x′ and retrieving the value of f(x′).

20. The method of claim 19 wherein said step of calculating further comprises the substeps of
retrieving a second value of f(x″) from the table for interpolation;
linearly interpolating between the value and second value of f(x″) using a fractional part of x′ as an interpolation factor to obtain an interpolated value of x′;

21. The method of claim 19 wherein said step of calculating comprises the step of calculating a value of f(x″) using a series expansion.

22. A signal processing system comprising:
processing circuitry for obtaining a value for the function f(x) for an input data point x taken over an unnormalized range and operable to:
shift the input data point x by a selected number of places to normalize the value of x to a normalized data point x′ in the normalized range;
calculate a value of f(x″); and
shift the value of f(x″) a selected number of places to renormalize and obtain a result of f(x) over the unnormalized range for the input value x.

23. The signal processing system of claim 22 wherein the signal processing circuitry operates on fixed point values of x and x′.

24. The signal processing system of claim 22 wherein said processing circuitry comprises a digital signal processor.

25. The signal processing system of claim 24 wherein said digital signal processor forms a part of an audio data processing device

26. The signal processing system of claim 25 wherein said digital signal processor forms a part of a dual signal processor audio data processing device.
